(19) United States
(12) Patent Application Publication
(10) Pub. No.: US 2009/0071028 A1
(43) Pub. Date: Mar. 19, 2009

(54) DEVICE FOR RETAINING MATERIAL FOR DRYING

(75) Inventors: Martin Gädke, Hofheim/Taunus (DE); Uwe-Jens Krausch, Brieselang (DE); Harald Moschütz, Grossbeeren (DE); Kai Nitschmann, Neuenhagen b. Berlin (DE); Peter Nober, Rommersheim (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, München (DE)

(21) Appl. No.: 10/576,370

(22) PCT Filed: Oct. 20, 2004
(86) PCT No.: PCT/EP2004/052592

§ 371 Date: Nov. 26, 2008

(30) Foreign Application Priority Data
Oct. 21, 2003 (DE) 103 48 837.5

(51) Int. Cl. F26B 11/02

(52) U.S. Cl. 34/108

(57) ABSTRACT

A device for retaining material for drying in a static position within a drying device with a preferably rotating drum. The material for drying may be positioned such that the surface of the material for drying exposed to a dry air stream is maximized. A spacer with an at least partly flexible embodiment is provided, on which the material for drying may be arranged and which may be placed in an essentially curved form, along with the material for drying, such that overlapping regions of the material for drying are arranged at a radial separation from each other.

The invention relates to a device for retaining material for drying according to the type defined in detail in the preamble of claim 1.

Known from DE 101 03 986 A1 is a drying rack for a laundry drier which is provided for the static arrangement of items for drying in a drum of a laundry drier. For this purpose the drying rack is fixed to a mounting plate of the laundry drier using fixing lugs so that the drying rack is arranged statically inside the rotating drum.

With this type of drying rack it is possible to dry items for drying which must not be moved during the drying process to avoid shrinkage of the items for drying, as in the case of hosiery goods or woolen items of clothing, or to avoid any damage to items for drying such as shoes.

It is further provided that the drying rack is surrounded with an external casing which is executed as closed in the circumferential direction of the drum. This should avoid items to be dried which are arranged statically in the drying rack from coming into contact with the rotating drum and being damaged.

Since certain items for drying such as woolen articles of clothing exhibit no wicking, it can sometimes take a very long time before these items of clothing have a desired degree of drying. In order to achieve a desired drying result within acceptable drying times for these items to be dried, it has been proposed to use an inner rack inserted in the drying rack which is arranged inside the outer casing and has a plurality of levels on which a plurality of items for drying can be distributed or on which only a single item for drying can be distributed.

In this case, it is possible to arrange individual areas of an item of clothing, such as the sleeves and the chest area of a pullover for example, distributed on the various levels of the internal rack and spaced apart from one another to enlarge the surface area of the items to be dried in the laundry drier which is exposed directly to the dry air stream in the laundry drier.

A disadvantage however is that complex folding procedures need to be observed for an arrangement of the items of clothing for drying or a garment for drying on the various levels of the inner rack which promote the drying process. These folding procedures for the special arrangement of the items of clothing on the internal rack undesirably require an expensive explanation by instructions for use or instruction of an operator of the laundry drier by specialist staff so that the handling of the internal rack for an operator is disadvantageously complex without the aforesaid aids.

It is thus the object of the present invention to provide a device for retaining items to be dried inside a drying device which can maximise the surface area of the material for drying exposed to the dry air stream and is easy for an operator to handle.

This object is solved according to the invention by a device for retaining material to be dried according to the features of claim 1.

With the device for retaining material for drying according to the preamble of claim 1, which is embodied as having an at least partly flexibly designed spacer on which the material for drying may be arranged and which together with the material for drying can be brought into such a substantially curved form, overlapping regions of the material for drying are arranged at a distance from one another so that a surface of the material for drying exposed to a dry air stream, such as woolen pullover, suit trousers or skirts is maximised without expensive preparatory activities of an operator.

The easy handling of the device for retaining according to the invention is obtained from the fact that before being inserted in the drier device, the material for drying is merely laid on the spacer and can be brought into the substantially curved form or in an at least approximately spiral state in which overlapping regions of the material for drying are spaced apart from one another, for example, by means of rolling up without the material for drying needing to be brought by an operator into an advantageous state for the drying process as in known devices from the prior art according to expensive folding instructions.

Advantageous embodiments of the invention form the subject matter of the dependent claims.

In a preferred and inexpensive embodiment of the subject matter according to the invention, the spacer is made of such a flexible material that it can be reversibly brought from an at least approximately flat state in which an item to be dried is laid on the spacer into an at least approximately spiral state in which the item to be dried is dried in the drier device and in which overlapping regions of the item to be dried are arranged at a distance from one another.

In an alternative advantageous embodiment of the spacer, it can be provided that the spacer is formed from a plurality of pin-connected segments which can be pivoted with respect to one another such that the spacer can be reversibly brought from an at least approximately flat state in which an item to be dried is laid on the spacer into an at least approximately spiral state in which the item to be dried is dried in the drier device and in which overlapping regions of the item to be dried are arranged at a distance from one another. It can further be provided that the segments are constructed rigidly and/or flexibly and have the same or different width in the longitudinal direction of the spacer.

The afore-mentioned features of the segments can be combined in any fashion such that a spacing between overlapping regions of the material for drying in the at least approximately spiral state of the spacer can be adjusted in a fashion especially advantageous for the drying process.

Furthermore, the segments can be interconnected by means of hinge devices such that a possible angle of pivot between two segments starting from a zero position is greater in one of the directions of pivot than in a direction of pivot opposite thereto. This advantageously has the result that rolling the spacer into the at least approximately spiral-shaped state in which the material for drying placed on the spacer is dried, ensures that by pivoting the segments in the direction of pivot of the smaller pivot angle there is a sufficiently large spacing between the overlapping regions of the material for drying without the material for drying sticking between two segments which can pivoted towards one another. In addition, by pivoting the individual segments in the direction of pivot of the larger angle of pivot without the material for drying placed therein, it is also possible to bring the spacer into a spiral-shaped state in which the segments have only a small spacing from one another and the spacer has a particularly space-saving shape, i.e. requiring only a small storage space.

In order to promote a drying process, in a further development of the subject matter of the invention, the spacer can be designed so that the dry air stream and preferably waste air enriched with moisture flows through the spacer at least in parts. Starting from the spacer, the material for drying is then also exposed to the dry air stream of the drier device in a contact area between the spacer and the material for drying, and waste air laden with moisture can be removed from the contact area through the spacer out from the drier device.

In a simple and functional further development of the subject matter of the invention, the spacer is made at least partly from an air-permeable material, such as a reticulated PUR foam, a random nonwoven or a spacing knitted fabric.

Should the device according to the invention for retaining material for drying be used in a drier device comprising a rotating drum whose rotating movement cannot be deactivated during the operation of the drier device, the spacer can be placed on a drier basket known per se which can preferably be fixed in the area of a door of the drier device. This ensures that the material for drying is not moved during the drying process. This is especially advantageous preferably with knitted goods and items of clothing which would shrink during any movement during drying. The same applies to shoes or other goods for drying which could be damaged by the movement in the drum.

In a further advantageous embodiment, the resilient and damping properties are used and the spacer is placed directly in the rotating drum without the basket-like insert. The spacer is embodied such that during rolling together it fixes the item for drying (textile item) firmly between the individual layers and completely encloses it. The outer layer of the spacer protects the material for drying (textile item) from impacts during whirling around in the rotating drum. The fixing between the individual layers of the spacer reliably prevents any movement of the material for drying (textile item).

In order to ensure a particularly secure arrangement of the spacer on a drier basket, it can be provided that the spacer is fixed to the drier basket by means of a fixing device, preferably by means of belts or retaining clips.

In a particularly advantageous further development of the subject matter according to the invention it is provided that the spacer is held in its at least approximately spiral-shaped or at least partly curved state by a retaining unit where the retaining unit can be embodied as a separate component or can be integrated in the spacer itself.

A particularly simple and inexpensive embodiment of the retaining unit is provided if, in its at least approximately spiral-shaped state, the spacer is executed with a layer of material at its open outer end which is of such a length that this loops around the rolled-up spacer over a certain circumference, preferably over one and a half times its entire circumference and holds this in its rolled-up position by means of adhesive friction. The material web can be similar to a toweling hand towel so that the facing of the material layer and the adhesive friction forces present in the contact area between the spacer and the material layer counteract the clamping force of the rolled-up spacer and hold this in its at least approximately spiral-shaped state. The use of the material layer is particularly advantageous if the spacer is arranged so that it lies at rest in a drier basket.

In a further advantageous embodiment of the subject matter according to the invention it is provided that the spacer is executed with a soft textile-protective surface at least on its surface facing the material for drying so that any damage to the material for drying is avoided and kinks and creasing on the material for drying is preferably avoided.

Further features and advantages of the invention are obtained from the following description of an exemplary embodiment with reference to the appended drawings. In the figures:

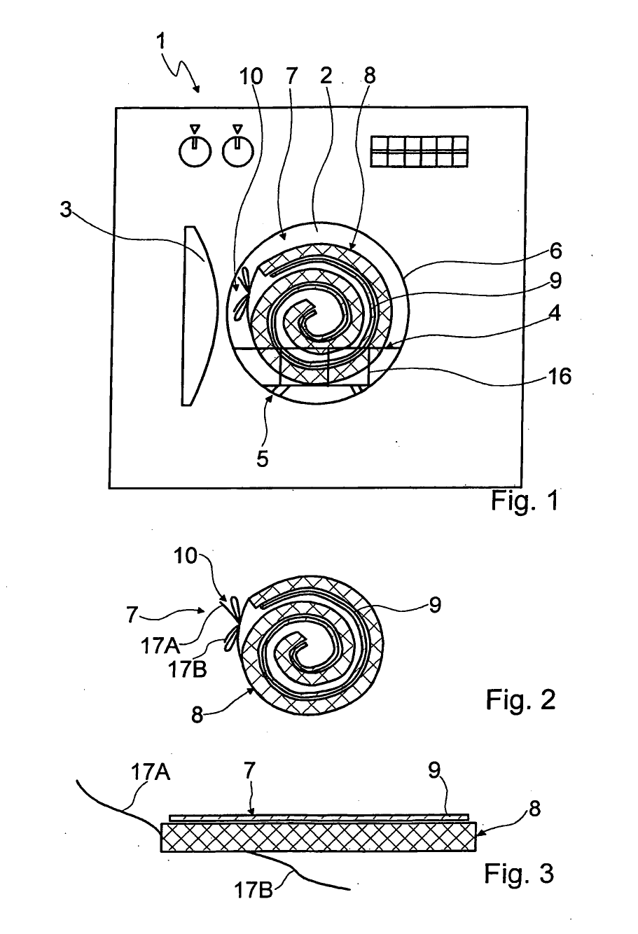

FIG. 1 is a schematic front view of a drier device comprising a device arranged therein according to the invention for holding material for drying;

FIG. 2 is a first embodiment of the device according to the invention shown highly schematically comprising a spacer in an at least approximately spiral-shaped state;

FIG. 3 is the device according to FIG. 2 with the spacer in an at least approximately flat shape;

FIG. 4 is a second embodiment of the device according to the invention shown highly schematically comprising a spacer in an at least approximately spiral-shaped state, executed as a plurality of rigidly constructed and pin-connected segments; and

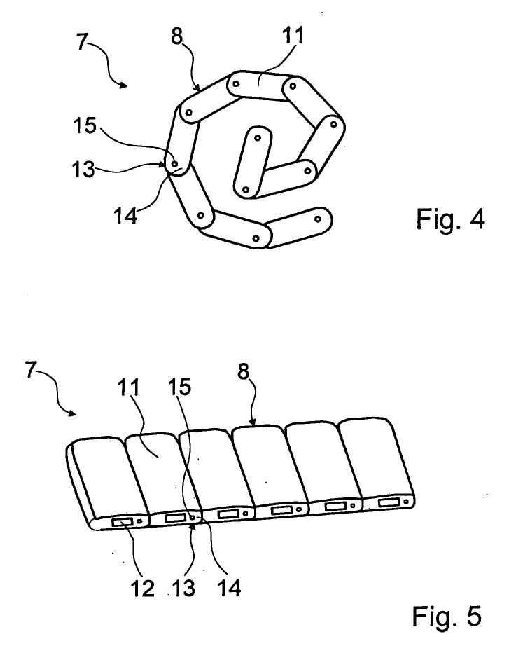

FIG. 5 is a three-dimensional view of the spacer of the device according to FIG. 4 in its at least approximately flat state.

The drying device 1 shown in FIG. 1 is executed with a drum 2 which rotates about a horizontal axis, provided in its interior with laundry entraining devices not shown in detail to move the laundry during rotation of the drum. Furthermore the drier device 1 embodied as a laundry drier is constructed in a fashion known per se comprising a fan, a heating device and a condenser in order to produce an air circuit completed by an air channel through the drum 2.

During the drying process air heated by the heating device or a dry air stream is guided into the interior of the drum 2 through a perforated outer surface of the drum 2. Material to be dried or laundry to be dried is exposed to the dry air stream there, this dry air stream being enriched with moisture. The moist dry air stream is then passed as waste air to a fluff sieve arranged inside a drier door 3 which closes the filling opening of the drier device 1. From there the waste air enriched with moisture is passed via the air channel to the condenser where the waste air is cooled. The moisture absorbed inside the drum in the form of water vapour is thereby condensed and led off to a storage container or to the environment. After the waste air has passed the condenser, the air stream from the blower is again fed to the heating device and is there heated to the desired drying temperature.

Provided inside the drum 2 is a drier insert 4 of a device 7 for retaining material to be dried in a static position inside the drum 2 which in the present case is embodied as basket-like and preferably comprises a plurality of hoops 16. This drier insert 4 is fixed to a wall 6 of the drier device by means of a plug device 5 in the door area of the drier device 1 such that even when the drum 2 is rotating, the drier insert 4 is arranged in a static position in the interior of the drier device 1, i.e. inside the drum 2.

Furthermore, located inside the drum 2 is a spacer 8 of the device 7 for retaining material to be dried in a static position in the drum 2 of the drier device 1. The spacer 8 is placed on the drier insert 4 and is made of a flexible material so that the spacer 8 can be reversibly brought from an at least approximately flat state shown in FIG. 3 and FIG. 5 into an at least approximately spiral state shown in FIG. 2 and FIG. 4, where the spacers 8 shown alone in FIG. 2 and FIG. 3 and in FIG. 4 and FIG. 5 are two preferred embodiments of the device 7 according to the invention.

Alternatively, it can also be provided that the rotary movement of the drum 2 can be deactivated during the drying process. The spacer 8 without drier insert 4 is then inserted inside the drum 2.

Alternatively, in a further advantageous embodiment, the resilient and damping properties of the spacer can be used and the spacer without the basket-like drier insert 4 can be placed directly in the rotating drum 2. In this case, the spacer is embodied such that during rolling together it fixes the item for drying 9 (textile item) firmly between the individual layers and completely encloses it. The outer layer of the spacer 8 protects the material for drying 9 (textile item) from impacts during whirling around in the rotating drum 2. The fixing between the individual layers of the spacer 8 reliably prevents any movement of the material for drying 9 (textile item).

Before rolling up, textile material 9 for drying such as a pullover, trousers or a skirt is placed on the spacer 8 of the device 7 according to the invention, shown in the rolled-up state in FIG. 2, and is rolled up jointly with the spacer 8 preferably without kinking or creasing.

In the state shown in FIG. 2, the spacer 7 has a substantially curved shape so that overlapping regions of the textile material 9 for drying are spaced apart from one another in the radial direction. In the present case, the dry air stream and waste air enriched with moisture flows through the spacer 8 so that, starting from the spacer 8, the material 9 for drying is also exposed to the dry air stream in a contact area between the spacer 8 and the material 9 for drying. Furthermore, if the spacer 8 is embodied as air- and moisture-permeable, it is possible for waste air laden with moisture to be guided from the material 9 for drying in the direction of the spacer 8 into the interior of the drum 2 and from there it can be guided through the door in the direction of the condenser.

In the present case, the spacer 8 is made of a reticulated PUR foam through which both the dry air stream and moisture-laded waste air can flow. During the production of the PUR foam the process parameters are adjusted so that the internal air bubbles of the foam burst and only the corner constructions of the foam structure are retained. A porous and reversibly bendable material is thus available which is embodied inexpensively and with a textile-protective surface.

Naturally it is also within the discretion of the person skilled in the art to use plastic other than polyurethane for producing the substantially mat-like spacer, which can be used to produce spacers having the features described previously and which have the required strength and temperature resistance.

In addition, depending on the present application, it is also possible to make the spacers from a random nonwoven or a spacing knitted fabric. Furthermore, it is also within the discretion of the person skilled in the art to produce a spacer from a combination of reticulated PUR foam and/or a random nonwoven and/or a spacing knitted fabric. In this case, a spacer can be formed, for example, from a plurality of layers of the aforesaid material arranged one above the other and joined firmly to one another and/or by regions arranged one after the other, extending in the longitudinal direction of the spacer 8, consisting of one of the aforesaid materials or from a combination of the materials.

It can also be provided that areas located inside the spirals of the spacer 8 are executed with a different, preferably higher porosity than is the case in the outer regions of the spiral-shaped spacer to achieve a uniform flow or exposure of the material for drying to the dry air stream.

In addition, the device 7 according to the invention is constructed with a retaining unit 10 for retaining the spacer 8 jointly with the material 9 for drying in its at least approximately curved or spiral-shaped state wherein in the exemplary embodiment of the device 7 shown in FIG. 2 and FIG. 3, the retaining unit 10 is executed by means of two cords 17A, 17B firmly connected to the spacer 8, which are joined to one another in the rolled-up state of the spacer shown in FIG. 2.

In a further development of the spacer not shown in detail, it is provided that a thin textile such as gauze or a net-like thin material is arranged at one end of the spacer and forms a last layer which compactly surrounds the rolled-up spacer in the sense of a net. This has the result that the wound-up spacer cannot wind up by itself and in addition, any areas of the material for drying standing above the spacer are pressed tightly against the spacer. This reliably avoids contact between the material for drying and the rotating drum during operating of the drying device 1 so that sensitive items for drying made of wool or other materials can be dried very gently and without any damage.

As an alternative to the cords 17A, 17B of the retaining unit 10 shown in FIG. 2, it can also be provided that the retaining unit is formed respectively by corresponding closure means preferably connected to the spacer, such as clip closures, button and buttonhole, magnets, a hook which engages in a predefined hole in the spacer, a belt with a snap-fit closure which engages in a receiving device, a closure executed in the form of a jigsaw-like piece or a cord clamped in a clamping device.

In addition, it is possible to fix clips of braces for fixing the outer free end of the spacer to a facing region of the spacer located thereunder or to slide clips over the layer of the spacer located thereunder to fix the free end of the spacer on the layer of the spacer located thereunder.

Further alternative embodiments of the retaining unit are covers such as a tube or a bag, for example into which the spacer is inserted or placed.

In a further alternative embodiment of the spacer, it is provided that the retaining unit is integrated in the spacer, preferably in the form of a spring element which pulls the spacer into the spiral shape as a result of production-induced internal stresses. The spacer must then be unrolled by an operator into an at least approximately flat state before rolling up the material for drying and automatically rolls up after being released.

In this case, it can also be provided that the spacer itself is produced with an internal stress profile in its longitudinal direction during manufacture such that the at least approximately spiral-shaped state of the spacer is automatically established as a result of its internal stresses without an additional spring element since this state is an equilibrium state of the spacer.

FIGS. 4 and 5 show a further exemplary embodiment of the device 7 according to the invention comprising a spacer 8 where the spacer 8 comprises a plurality of pin-connected segments 11 also made of an air- and moisture-permeable material. The spacer 8 according to FIG. 4 and FIG. 5 like the spacer according 8 according to FIG. 2 and FIG. 3 is a structure which can be brought into a screw-shaped or spiral shape, allowing items of clothing to be placed in the drier basket in the rolled-up state without kinking or creasing and dried therein without movement and contact with a rotating drum.

The individual pin-connected segments 11 of the device 7 according to FIG. 4 hold the individual layers of a textile material to be dried at a distance of about 1 to 2 cm. The segments 11 are provided with lateral openings 12 through which the dry air stream flows into the segments 11 and can come in contact with the interior surfaces of an item to be dried through the segments 11 of the spacer 9. For this purpose the walls of the segments 11 surrounding the inner openings 12 are made of perforated material or of air- and moisture permeable material executed in the manner described previously.

In the present case, the segments 11 are constructed with articulated devices 13 which are designed with a region 14 which respectively overlaps an adjacent segment 11 on one side of the segment 11 and a rivet joint 15 engaging in the overlapping region 14 and in the segment 11 overlapped thereby. The rivet joint 15 has the result that the individual segments 11 are connected firmly but rotatably to one another.

In a further development of the spacer according to FIG. 4 and FIG. 5, the individual segments can be spaced with respect to one another in the longitudinal direction of the spacer and so-called spacing elements can be provided between the segments via which the segments are connected to one another in an articulated fashion. In this case, the hinged movement between the segments can be embodied by means of hinged joints known per se and/or by a flexible design of the spacing elements and/or a flexible design of the segments themselves.

When the drier device 1 is operated without the device 7 according to the invention for retaining material for drying according to FIG. 2 or FIG. 4, as a result of its embodiment the spacer 8 can be stored in a space-saving manner in the rolled-up state.

In a further development of the device according to the invention according to FIG. 4, it is provided that the retaining unit 10 is integrated in the articulated devices 13 in the form of a locating mechanism which holds the segments together in each case at an angle adjusted by the operator. If the angle between the individual segments is to be varied, the segments must be adjusted from one locating position of the locating mechanism into a locating position of the locating mechanism corresponding to the desired angle by application of an adjusting force where the locating mechanism can have an arbitrary number of locating positions.

In addition, it is naturally within the discretion of the person skilled in the art to construct the spacer 8 of the device 7 according to FIG. 4 with one of the embodiments of the retaining unit described previously.

The spacers 8 of the devices 7 according to FIG. 2 and FIG. 4 preferably each have a length of about 1.20 m and a depth of about 0.3 m whereby suit trousers can advantageously be dried in a protected manner using the spacer 8 in a space-saving and rolled-up position.

### REFERENCE LIST

1 Drier device, laundry drier
2 Drum
3 Drier door
4 Drier insert
5 Plug device
6 Wall
7 Device
8 Spacer
9 Material for drying
10 Retaining unit
11 Segments
12 Central openings
13 Articulated devices
14 Overlapping region
15 Rivet
16 Hoop
17A, 17B Cord

1-17. (canceled)

18. A device for retaining material for drying inside a drying device comprising a drum, wherein the material for drying is positioned such that a surface of the material for drying exposed to a dry air stream is maximized, wherein an air-permeable spacer embodied as at least partly flexible is provided, on which the material for drying may be arranged and which together with the material for drying can be brought into a form such that overlapping regions of the material for drying are spaced apart one another, wherein the spacer is formed from a plurality of pin-connected segments which can be pivoted with respect to one another such that the spacer can be reversibly brought from an at least approximately flat state into an at least approximately spiral state.

19. The device according to claim 18, wherein the segments are formed from a rigid material.

20. The device according to claim 18, wherein the segments are formed from a flexible material.

21. The device according to claim 18, wherein a width of each segment is substantially the same.

22. The device according to claim 18, wherein the segments are interconnected by means of hinge devices, wherein a possible angle of pivot between two segments starting from a zero position is greater in one direction of pivot than in a direction of pivot opposite thereto.

23. The device according to claim 18, wherein the dry air stream and waste air enriched with moisture flows through the spacer at least in parts so that, starting from the spacer, the material for drying is also exposed to the dry air stream in a contact area between the spacer and the material for drying and that waste air laden with moisture can be removed from the contact area in the direction of the spacer.

24. The device according to claim 18, wherein the spacer is formed from an air and moisture permeable material.

25. The device according to claim 24, wherein the spacer is formed from a reticulated PUR foam.

26. The device according to claim 24, wherein the spacer is formed from a non-woven material.

27. The device according to claim 24, wherein the spacer is formed from a spacing knitted fabric.

28. The device according to claim 18, wherein the spacer is laid on a drier insert.

29. The device according to claim 28, wherein the spacer is fixed on the drier insert by means of a fixing device.

30. The device according to claim 18, wherein the spacer is laid directly in the drum.

31. The device according to claim 18, wherein a retaining unit is provided for retaining the spacer in its at least approximately spiral state.

32. The device according to claim 31, wherein the retaining unit is integrated in the spacer.

33. The device according to claim 18, wherein the spacer is formed with a soft textile-protective surface on its surface facing the material for drying.

34. A clothing dryer for drying a clothing item comprising:
a housing;
a rotating drum disposed within the housing;
an air-permeable spacer receiving the clothing item and being positioned within the rotating drum in a form such that overlapping regions of the material for drying are spaced apart from one another to increase the surface of the clothing item exposed to a dry air stream, the spacer including a plurality of pin-connected segments being formed from an air and moisture permeable material that are pivotable with respect to one another such that the spacer can be reversibly positioned from a flat state to a spiral state.

35. The clothing dryer according to claim 34, wherein the spacer is formed from a reticulated polyurethane foam material.

36. The clothing dryer according to claim 34, further comprising a dryer insert disposed within the drum and supporting the spacer in a fixed position with respect to the housing while the drum is rotating around the spacer.

37. The clothing dryer according to claim 34, wherein the spacer includes a retaining unit retaining the spacer in the spiral state.

38. The clothing dryer according to claim 34, wherein each of the plurality of segments includes a lateral opening extending into the segment for receiving a dry air stream flow into the segment.

39. A clothing dryer for drying a clothing item comprising:
a housing;
a rotating drum disposed within the housing; and
an air-permeable spacer receiving the clothing item and being positioned within the rotating drum in a form such that overlapping regions of the material for drying are spaced apart from one another to increase the surface of the clothing item exposed to a dry air stream, the spacer being formed from a reticulated polyurethane foam material being porous, an air and moisture permeable, and reversibly bendable from a flat state to a spiral state.
